(19) United States
(12) Patent Application Publication
(10) Pub. No.: US 2015/0247077 A1
(43) Pub. Date: Sep. 3, 2015

(54) Adhesive Composition and Method to Join Non-Oxide Silicon Based Ceramic Parts

(71) Applicants: Larry J. Kepley, Placitas, NM (US); George M. Jacobsen, San Diego, CA (US)

(72) Inventors: Larry J. Kepley, Placitas, NM (US); George M. Jacobsen, San Diego, CA (US)

(73) Assignee: Thor Technologies, Inc., Albuquerque, NM (US)

(21) Appl. No.: 14/331,121

(22) Filed: Jul. 14, 2014

Related U.S. Application Data
(63) Continuation-in-part of application No. 12/931,187, filed on Jan. 26, 2011, now abandoned.

(51) Int. Cl. C09J 183/00; C08K 3/34; C08K 3/38; C09D 183/00

(52) U.S. Cl. CPC C09J 183/00; C09D 183/00; C08K 3/34; C08K 3/38

(57) ABSTRACT

The present invention comprises an adhesive composition and a method of using the composition to join non-oxide, silicon-based ceramic parts. The composition is a non-aqueous paste comprising high levels of non-oxide powders, silicon carbide or silicon nitride powder blended with a mixture of polymeric precursors to silicon carbide and zirconium boride. The resulting blend of the present invention is capable of decomposing on heating (in an inert or reducing atmosphere) into Si-based ceramic phases. The powder is fully suspended and dispersed in the polymer such that pockets of dry powder are not present. Although the polymer penetrates between particles and wets the surfaces to be joined, it does not prevent some contact between particles and the surface. Because the paste contains only low levels of volatile solvents and it converts into Si-based ceramics upon pyrolysis, it provides strong chemical bonding to Si-based ceramics.

### CROSS-REFERENCE TO RELATED APPLICATION

I hereby claim the benefit under Title 35, United States Code Section 119(e) of any U.S. Provisional Application(s) listed below:

Application Ser. No.: 12/931,187

### Filing Date: Jan. 26, 2011

### STATEMENT REGARDING FEDERALLY SPONSORED RESEARCH AND DEVELOPMENT

This invention was sponsored in part by funds from the US Naval Air Warfare Center Aircraft Division under contract N6833508C0488

### THE NAMES OF THE PARTIES TO A JOINT RESEARCH AGREEMENT

Not applicable

INCORPORATION-BY-REFERENCE OF MATERIAL SUBMITTED ON A COMPACT DISC

Not applicable

### BACKGROUND OF THE INVENTION

1. Field of the Invention

The present invention relates generally to non oxide-based ceramic parts; more particularly to the joining of ceramic parts and ceramic matrix composites; and even more specifically, to adhesive, pre-ceramic compositions and methods to join silicon-based ceramic parts or ceramic matrix composites at lower than standard processing temperatures for silicon-based ceramics.

2. Description of the Related Art Including Information Disclosed Under 37 CFR 1.97 and 37 CFR 1.98

The following description of the art related to the present invention refers to a number of publications and references. Discussion of such publications herein is given to provide a more complete background of the scientific principles related to the present invention and is not to be construed as an admission that such publications are necessarily prior art for patentability determination purposes.

The adhesives and methods to join non-oxide based, ceramic parts or ceramic matrix composites (CMCs) presently available are woefully inadequate. Materials possessing improved adhesive properties and suitable methods of using those improved adhesives are therefore needed. The envisioned uses of such materials and methods include, but are not limited to: (1) very high temperature engineering applications involving non-oxide refractory materials such as kilnware, heating elements and shields; and (2) structural and thermal protection components of spacecraft, rocket nozzles, and hot-section components of gas turbines. Resistance to heat and oxidation are essential for those specific uses.

Improved adhesive materials are needed to join materials with similar properties as well as materials with divergent properties. Examples of typical joining processes for which suitable adhesives and methods are lacking are the attachment of wires, pipes, and sensors to non-oxide based ceramics. Stronger more heat resistant adhesives are also needed to support the testing of the mechanical strengths of thin, fiber-reinforced CMCs, such as silicon-carbide-fiber reinforced silicon carbide (SiC/SiC), at high temperatures, in particular the testing of interlaminar tensile (ILT) strength, which requires attachment of the pull-rod faces of tensile testing equipment to the faces of thin, flat specimens. The attachments exemplified above cannot be achieved by gripping or use of mechanical fasteners, due to the thinness (e.g., 0.1 in.) of the specimens and need for application of stress evenly over the surfaces.

Epoxy based adhesives, such as those used for bonding and ILT testing at room temperature under standard test method (ASTM C1468), decompose and fail at high temperatures. Even the highest temperature, polymer-based adhesives (e.g., polyimide-based products) experience decomposition at temperatures above 500-600° C. Higher temperature adhesives, which contain high temperature ceramic oxides like mullite, alumina, silicones, silica, and metallic oxides, are capable of bonding to porcelain, glass, metal, and various oxide based ceramics at temperatures up to 3000° F. Those higher temperature adhesives, however, do not provide high bond strength to non-oxide ceramics, such as silicon carbide (SiC), silicon nitride (Si₃N₄), and the like. Refractory cement formulations featuring alumina, silicon carbide, silicon nitride, and other silicon-based materials have been shown to be useful in the fabrication of furnace linings. Those cement-like materials have not been proposed for bonding structural ceramic materials.

The prior art discloses adhesive materials which possess some desirable qualities, however, none of them match the overall characteristics and applicability of the composition of the present inventions. For example, U.S. Pat. No. 4,090,881 to Keel et al., discloses and claims an inorganic refractory adhesive comprising mullite, silica, a clay suspension agent and ceramic fibers. The Keel et al., material appears to be an effective adhesive at temperature of 2000° F. for metallic electrical heating elements. Even at high temperatures, the adhesive material is non-conducting due to the lack of zirconium in the mixture.

U.S. Pat. No. 5,468,290, to Kelley discloses and claims a ceramic adhesive comprising metallic oxides (zirconium, silicon, aluminum), alkali silicates, and SiC whiskers. The Kelley adhesive possesses improved thermal conductivity, coefficient of thermal expansion (10-14 pp./° K) close to that for steel, and fracture toughness for bonding to steel in engine applications.

U.S. Pat. No. 4,255,316, to Blizzard discloses and claims a silicone adhesive consisting of organosiloxanes, silica, alumina, and magnesium oxide. The Blizzard material can be converted to a quartz free ceramic. The invention disclosed and claims in Blizzard overcomes one of the hurdles of many silicone based adhesives which tend to lose their joining ability when combined with large amounts of powder filler. The softening temperature of the Blizzard material is 800° C. and it is used primarily for joining greenware components.

U.S. Pat. No. 4,476,234 to Jones et al., discloses and claims a composition comprising a binder of silica, iron oxide, silicon powder, and calcium oxide with filler of alumina, silicon carbide, mullite, and/or kyanite. Jones, et al., do not claim their mixture as an adhesive but rather as a material for fabrication of materials like furnace walls, with operating temperatures up to 1400° C.

U.S. Pat. No. 4,931,531 to Tamai et al., is part of a group of prior art references which disclose and/or claim polyimide chemical compositions. Tamai et al., discloses and claims a polyimide compound that shows improved process ability and high temperature adhesive properties compared to more conventional resin adhesives. The suggested operating temperature of Tamai et al.'s compounds is approximately 530° C. The group of polyimide prior art references suggest properties of the adhesive such as wear resistance, favorable electrical properties, flame resistance, etc. Polyimide adhesives can be modified through addition of fillers like ceramic powders and fibers, flame retardants, and various metals/metal oxides.

U.S. Pat. No. 5,928,448 to Daws discloses and claims a method for repairing ceramic matrix composites using a combination of mechanical and adhesive bonding. While the mechanical bonding using dowels and a patch appear to constitute the preferred embodiment of Daws' invention, Daws' suggests the need for a chemical adhesive. In that regard, Daws' patent suggests a high temperature ceramic adhesive comprising as various resins, polymeric precursors to ceramics, or glass fits with or without ceramic reinforcement agents.

Commercially available aluseal Adhesive Cement No 2 from Sauereisen (www.sauereisen.com) is an adhesive used for bonding porcelain, glass, and metal that shows good thermal shock resistance, heat conductivity, and electrical resistance. Its CTE is well matched to bond to oxide based ceramics and is capable of retaining its strength (modulus of rupture up to 3400 psi) at temperatures up to 3000° F.

The prior art also discloses several methods of joining or bonding to SiC or silicon nitride, including metal brazing, diffusion bonding (e.g., of SiC to titanium foil), and liquid-phase sintering at very high temperatures. For example, compounds have been reported useful for liquid-phase bonding of silicon nitride parts by applying heat and pressure, in the ranges 1450-1650° C. and 0-5 MPa, resulting in joints about 10 microns thick. (R-J. Xie, M. Mitomo, L.-P. Huang, and X.-R. Fu, J. Mat. Res., 15(1), 135-141 (2000).

The use of a resin (polysiloxane resin YR3184, GE Toshiba Silicones) for joining SiC ceramics at 1200° C. has been reported. In that instance, Applicants are unaware of reported data which would allow the determination of the joint strength at high temperatures. In any event, the reported joint thickness is too thin (2-5 microns) for many applications. (Yuan, Xiaokun; Chen, Shu; Zhang, Xuehong ; Jin, Tounan, “Joining SiC ceramics with silicon resin YR3184”, Ceramics International, ISSN: 02728842, Vol: 35, Issue: 8, Date: December, 2009, Pages: 3241-3245).

Joints from metal brazing have poor oxidation resistance and low strength at high temperatures. Joining compounds based on metal oxides used as additives for liquid-phase sintering of silicon nitride ceramics at temperatures >1350° C. can have limited temperature capability (about 1000° C.), due to the low softening temperature of the resulting intergranular glass. (R. Ramesh, E. Nestor, M. J. Pomeroy, S. Hampshire, J. Eur. Ceram. Soc., 17, (1997) 1933). Furthermore, fiber reinforced ceramic matrix composites like SiC/SiC, cannot withstand the high processing temperature (>1350° C.) without adverse alteration of material properties, such as ultimate strength, due to changes in crystallinity, microstructure or phase boundaries. Applicants are unaware of any chemical composition, adhesive, or process useful to join non-oxide, Si-based ceramics with a processing temperature below 1400° C. that results in good strength and oxidation resistance at ≧1200° C., with the possible exception of YR3184 (GE Toshiba Silicones), which shortcomings and limitations Applicants have pointed out above.

High-temperature ceramic adhesives are needed to join non-oxide ceramic materials and composites, in particular, the carbides, nitrides, or borides of metals and semimetals, as well as carbon and graphite based materials. More particularly, these adhesives must be able to join silicon and the carbides, nitrides, and borides of the following: silicon, boron, and refractory metals (e.g. Ti, Zr, Hf, V, Nb, Ta, Cr, Mo, W), and their composites, which we refer to as non-oxide based ceramics and ceramic composites. Those ceramics include, but are not limited to: silicon carbide, zirconium boride, hafnium boride, silicon oxycarbide, silicon nitride, and their mixtures. In addition to high service temperature (e.g., >1000° C.) in air, high bond strength is desired, capable of withstanding fracturing at stress levels where the non-oxide based ceramic composites fail (e.g., typical ILT strength of <5,000 psi).

There are adhesive products on the market with high service temperature for bonding to porcelain, glass, and metals. However, the composition of the adhesives of the prior art is ill suited for bonding to non-oxide, non-oxide based ceramics for the following reasons: (1) the resulting modulus of rupture is too low; (2) the coefficient of thermal expansion (CTE) is poorly matched (i.e., too high) to that for non-oxide based ceramics, for good bonding over a large temperature excursions, so bonding is not resistant to thermal shock; (3) the tensile strength is less than desired; (4) the adhesives' chemical compositions are too dissimilar to that of non-oxide based ceramics for chemical bonding to occur at reasonable temperatures (i.e., ≦1400° C.), and they may form glasses and may contain water; (5) the adhesives can promote oxidation of non-oxide based ceramics surfaces, inhibiting strong adhesion; and (6) excessive shrinkage can occur during drying, curing, or heating.

PCT patent WO 89/04344 teaches a composition comprising 50-85% by weight of SiC powder with 15-50% by weight of a preceramic polysilazane binder and method to prepare the composition, including pulverizing the mixture and separating and removing any particles having a particle size larger than about 105 micrometers. It further teaches how to attain SiC ceramics by molding the composition in a mold under hydraulic pressure of 6865-343,000 kPa (preferably 175,817-210,981 kPa (i.e, 25.1-30.6 ksi)), removing the green body from the mold, and pyrolyzing it in inert atmosphere to a temperature of 1200-1450° C. That reference does not teach or suggest any adhesive properties of the composition.

### BRIEF SUMMARY OF THE INVENTION

The adhesive composition of this invention is a non-aqueous paste comprising high levels of non-oxide powders, silicon carbide or silicon nitride powder; blended with a mixture of polymeric precursor to silicon carbide and polymeric precursor to zirconium boride or polymeric precursor to hafnium boride. The resulting blend of the present invention is capable of decomposing on heating (in an inert or reducing atmosphere) into non-oxide based ceramic phases. The powder is fully suspended and dispersed in the polymer such that pockets of dry powder are not present. Although the polymer penetrates between particles and wets the surfaces to be joined, it does not prevent some contact between particles and the surface. Because the paste contains only low levels of volatile solvents and it converts into non-oxide based ceramics upon pyrolysis, it provides strong chemical bonding to non-oxide based ceramics.

The adhesive of the present invention has good tensile strength, CTE values that match well to non-oxide based ceramics, and oxidation resistance at high temperatures. The consistency is such that the adhesive has good throwing power to fill surface roughness. The presence of zirconium-boride precursor promotes sintering of the paste during firing of assemblies under inert or reducing atmosphere at >1000° C. In particular, the zirconium-boride or hafnium boride precursor enables consumption or reduction of superficial surface oxides inherent on Si-based ceramics and it promotes reaction bonding to the surface of non-oxide based ceramics. The paste pyrolyzes into ceramic phases in quite high yield (>90% of cure weight), with little shrinkage, at temperatures below 1400° C. Thusly, the pyrolyzed paste can be used safely with CMC materials.

The high temperature adhesive of the present invention comprises a ceramic cement paste, the paste in turn comprising high levels of non-oxide powders, silicon carbide or silicon nitride powder, blended with a mixture of polymeric precursor to silicon carbide and polymeric precursor to zirconium boride or polymeric precursor to hafnium boride. The resulting blend of the present invention is capable of decomposing on heating (in an inert or reducing atmosphere) into carbide and boride-based ceramic phases.

### BRIEF DESCRIPTION OF THE SEVERAL VIEWS OF THE DRAWINGS

The accompanying drawings, which are incorporated into and form a part of the specification, illustrate an embodiment of the present invention and, together with the description, serve to explain the principles of the invention. The drawings are only for the purpose of illustrating a preferred embodiment of the invention and are not to be construed as limiting the invention.

FIG. 1: shows an adhesive bonded specimen-rod assembly for high temperature, interlaminar-tensile-strength testing.

### DETAILED DESCRIPTION OF THE INVENTION

In the preferred embodiment of the invention, a paste formulation is synthesized by blending a mixture of polymeric precursor to nominally SiC and polymeric precursor to metal boride where the metal is zirconium or hafnium (i.e., precursor to the ceramic compound with nominal composition MB₂ where M is Zr or Hf); on the one hand, with non-oxide ceramic powders, such as SiC or Si₃N₄; on the other hand, with the powder to precursor ratio ranging from 0.5:1 to 4:1 by weight (i.e., paste containing 33% to 80% powder by weight and 67% to 20% polymer by weight, respectively). The Si-based, pre-ceramic polymeric precursor to SiC of this invention is either polycarbosilane or polysilazane polymer, some of which are available commercially, and which yield SiC or nitrogen-doped SiC upon pyrolysis. The chemically reactive precursor polymer of formula (I) to metal boride is obtained by the method of Kepley et al. [U.S. Pat. No. 8,236,718] and is added to promote bonding to surfaces, sintering of the paste and reduction of silicon oxides.

[MBₓH_{y}]ₙ (I)

where M is Zr or Hf, x is from 1 to 2, y is from 0 to 9, n is ≧4,

This method relies on and extends the teachings of Tebbe et al., U.S. Pat. No. 5,364,607, which teaches a method to produce insoluble zirconium- or hafnium-boride precursor complex as a solid precipitate or film, by deposition from solution,
“comprising contacting a solution of M(BH₄)₄ wherein M is Zr or Hf with a Lewis base (LB), to yield the desired precursor complex as a solid precipitate or film. This reaction is as follows:

2M(BH₄)₄+4LB→[(LB)(BH₄)₂MH]₂(μ-B₂H₆)+H₂+2H₃B-LB
In favorable cases when the Lewis base is a large bulky group, such as triphenylphosphine, the above intermediate is unstable with respect to dissociation of the Lewis base. Once liberated, the Lewis base extracts another BH₃ and a soluble, base-free intermediate is formed according to the following reaction:

2[(LB)(BH₄)₂MH]₂(μ-B₂H₆)→M₄(B₂H₆)(BH₄)₆+4H₃B-LB
As further hydrogen is evolved, the metal borane complex of formula (II) precipitates as a black solid.”

[MB₂Hₓ]ₙ (II)
wherein M is Zr or Hf, x is from 0 to 9, and n is a least 4. This complex has a boron to metal ratio of about 2.
   This metal boride precursor complex in Tebbe et al, “comprises a mixture of oligomers of formula (II)”. “Heating the solid of formula (II) above about 200° C. yields the metal boride MBₓ, wherein x is about 2.”

The Tebbe patent lists “suitable Lewis bases for use in this reaction sequence include: phosphines, arsines, amines, and ethers.” Tebbe discloses that the phosphines are preferred, “especially aryl- or alkylphosphines having a cone angle greater than 135°.” “Most preferred are the arylphosphines. Use of a bulky tertiary phosphine leads to hydrogen evolution, formation of (B₂H₆)²⁻ bridges, and precipitation of a base free solid of formula (II).” The art states that the concentration of the Lewis base must be determined (i.e., low enough), “so as to prevent precipitation of colorless H₃B-LB. The product of formula (II) precipitates as a black film or solid and is washed extensively with fresh solvent to ensure removal of any H₃B-LB.”

Applicants tested the Tebbe process to produce ZrB₂ precursor and fabricate ZrB₂ matrix composites, using the most preferred LB, an arylphosphine, specifically triphenylphosphine. Although formation of the complex appeared to occur, it proved difficult to remove the H₃B-LB from the precursor, particularly when bulk quantities of precursor were generated instead of thin films. It was not practical to wash the product with sufficient fresh solvent to ensure removal of the by-product H₃B-LB. A space filling, high purity precursor with high-volume yield was desired for the formation of the ceramic matrix of ceramic composites. Furthermore, a soluble or stable suspension formulation was desired for efficient and complete infiltration of fiber preforms or the coating of fibers with a thin (about 1 μm thick) layer of ZrB₂ precursor to enable formation the fiber-matrix interfacial layer prior to assembling the fibers into a preform.

We discovered that the lighter, liquid LB, triethylamine, which is a member of the amine family of Lewis bases, worked much better for reaction with M(BH₄)₄, because the reaction gave a stable liquid form of MBₓ precursor, where x is about 1.4, combined with a liquid H₃B-LB (i.e., borane triethylamine complex with m.p.=−4° C. and b.p.=97° C./12 mm Hg). Other amines, such as pyridine and diethylamine, gave the same result and similar precursor yield when used as the LB of the reaction. These amines have m.p.<−40° C., are liquids during the course of the reaction, and give complexes with borane that are liquids. The reaction to form precursor appeared to work in general with amines. The liquid H₃B-LB was easily distilled away from the precursor complex to produce a thick black oil or paste that was an ideal precursor formulation for fabrication of CFRCs or SiC-powder reinforced composite, whose ceramic matrix was nanocrystalline, amorphous and substoichiometric zirconium boride (ZrBₓ with x from 1 to 2) upon pyrolysis. Some of the liquid H₃B-LB could be left mixed with the precursor complex, acting as a solvent, to produce a stable dilute solution form of the precursor. It was ideal for infiltration of the preform and converted into an amorphous nominally ZrB₂ ceramic phase upon pyrolysis. The stable solution form obtained from the reaction mixture without further purification, other than removal of some of the borane amine complex, was dissolved into a polycarbosilane precursor to SiC or polysilazane precursor to SiCN to prepare liquid mixed precursor formulations that yielded a fine grained composite matrix of ZrBₓ—SiC. The mixed precursor formulation was used to prepare SiC fiber reinforced, SiC+ZrBₓ matrix composite panels by the PIP process using stacked SiC fabric plies as the preform via a standard autoclaving step. Lastly, the concentrated precursor solution was useful when mixed with SiC powder to form a high viscosity paste. The paste had sufficiently high ceramic volume yield upon pyrolysis to form a ceramic joint between SiC-based CMCs and a SiC surface.

Due to the similar reactivity of amine (NR₃) and phosphine (PR₃) Lewis bases with M(BH₄)₄ wherein M is Zr or Hf, nearly identical oligomeric metal-borane complex of formula I and II are formed, respectively, as the main product of the methods of Kepley et al. and Tebbe et al.; both are black polymer and free of base after purification by washing or pumping away the H₃B-LB side product. However, the LB of one method is a liquid and produces a liquid amine-borane complex as side-product, while the LB of the other is a solid and produces a solid phosphine-borane complex as side product. The smaller, lighter, and more polar liquid amine and H₃B-LB side product stabilize the polymer and inhibit solidification of I even when present at low levels. Thusly, polymer I is a liquid whereas polymer II is a solid. Elemental analysis of precursor polymer I digested in strong acid solution showed it was free of triethylamine except for trace amounts and that the B to M ratio, x, was 1.4. However, X-ray diffraction analysis of the matrix formed by pyrolysis of a mixture of precursor polymer I and SiC precursor polymer showed the presence of amorphous and hexagonal ZrB₂, so the value for x in formula I could fall between 1 and 2.

In contrast to the prior art, the studies supporting this application have showed that an amine is the preferred LB for the formation of MB₂ precursor useful for fabrication of CMCs and other ceramic matrix applications where a liquid precursor is beneficial, such as in the coating of fibers to produce the fiber-matrix interfacial layer or the infiltration of porous surfaces. The use of amine as the LB facilitated, among other accomplishments:

1. use of the LB as both reactant and solvent during and after reaction with M(BH₄)₄;

2. formation of a stable liquid precursor to ZrBₓ, which was miscible with other polymer precursors;

3. formation of bulk quantities of high purity precursor more efficiently;

4. efficient infiltration of woven fabric of SiC and C and oxide fibers;

5. pouring and draining of the precursor in concentrated form; and

6. incorporation of an alkylamine into the precursor formulation which is known to yield BN ceramic upon pyrolysis.

The weight ratio of Si-based polymeric precursor to the ZrB₂ precursor can be varied from >0 to 3, with a preferred ratio in the range 1 to 3. The ceramic precursors are then combined with fine SiC or Si₃N₄ powder of size less than 5 μm to form a thick but spreadable adhesive. It is not necessary to sieve the adhesive to remove large particles or particle agglomerates. Various additives (lithium aluminum hydride, zirconium hydride, iron oxide, rare earth oxides, precursors to metal carbides, e.g. hafnium carbide, amongst others) in dopant levels (<5%), can be used to improve bonding and sintering and oxidation resistance.

The process of the present invention is performed in a drybox due to the reactivity with air and moisture of the ZrB₂ precursor. The porosity and cracking of the fired adhesive are optimized for high contact area and good adhesion strength by adjusting the level of powder without ruining its dispersion in the polymers. A mixer/mill is used to ensure an optimal, intimate mixture of powders and precursors.

The process of this invention comprises (1) applying the ceramic paste to both surfaces of the parts to be joined; (2) pressing the parts being joined tightly together; (3) applying 1000 to 2000 psi of pressure to attain optimum bond strength; and (4) curing the resulting joined parts curing at temperatures of 100-300° C. to thermoset the adhesive; and (5) applying 200 to 5,000 psi of pressure during the curing step to obtain maximum strength.

The best bonding results are obtained when the graphite or ceramic substrates are assembled and pressed together inside of a snug fitting sleeve, which not only aligns all the parts, but also confines the paste to the joint regions and thusly enhances compaction and bonding of the cement during curing. The cement joint thickness can be varied in the range of 10-1000 microns by adjusting the amount of cement and pressure applied to the surfaces to be joined. A gasket is used either between or around the surfaces and surrounding the paste to confine it to a desired region. After curing, the resulting joints are quite durable and do not require special handling precautions. In fact, the joints can maintain their integrity after being dropping from a height of about two feet.

Ceramic joints durable at high temperatures are obtained through pyrolysis of the cured assemblies in a conventional inert atmosphere furnace. They are fired freestanding under nitrogen via 1-20° C./min temperature ramps up to 1350° C. with 30 min to 12 hour dwells. For improved sintering and bond strength, pressure is applied in the range 100 to 50,000 psi, preferably 5,000 to 10,000 psi, during the temperature ramp of firing, to induce local flow of the paste before pyrolysis of polymer precursors is completed. During the firing the preceramic polymers convert into ceramic phases that bond to non-oxide based ceramics and graphite. It is believed that some dissolution of surface phases and reaction of the adhesive with the surface occurs (i.e., local inter-diffusion of species at the interface to the SiC surface).

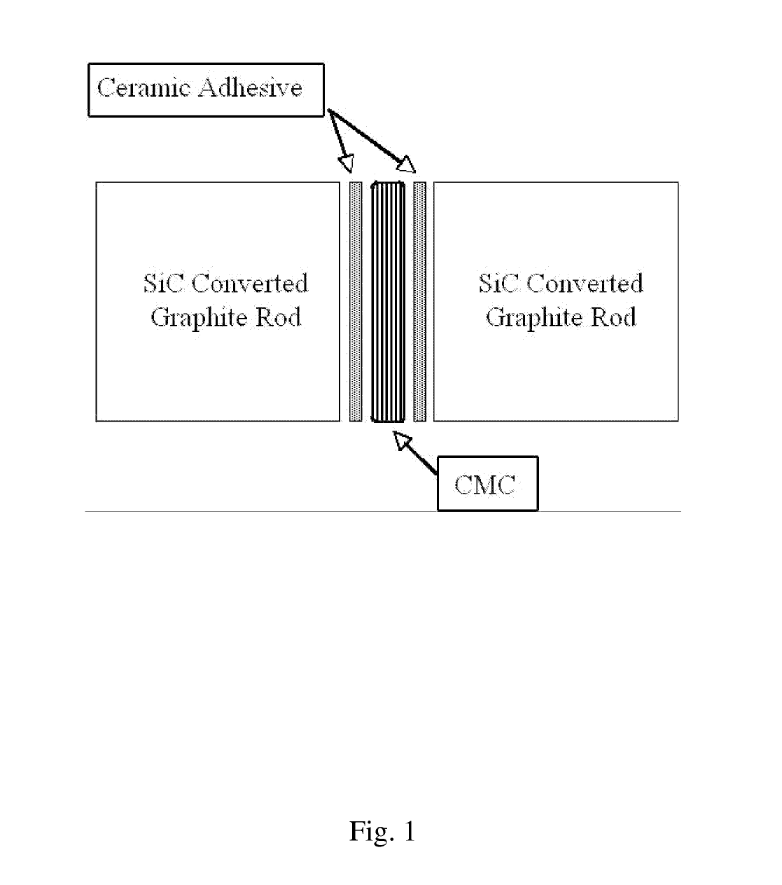

The ceramic adhesive can be used to bond SiC/SiC CMC specimen discs between two coaxial SiC-coated graphite rods, as depicted in FIG. 1. The surfaces of the graphite rods can be converted into SiC by a chemical-vapor-reaction (CVR) process or infiltration and firing of SiC precursor prior to their use, but similar results have been obtained without prior conversion of the graphite surfaces. The fired assemblies are then used to measure the high temperature interlaminar tensile strength of the SiC/SiC. The ceramic adhesive bonded to SiC/SiC with sufficient tensile strength and oxidation resistance to enable ILT strength testing in air up to 2300° F. The adhesive strength for bonding SiC surfaces together can be obtained by omission of the CMC specimen disc.

Tensile strength testing of the assemblies has been verified using an instrumented load train to measure the ultimate tensile strength. Tensile strengths of a SiC/SiC composite are obtained by bonding 1-in. diameter discs of SiC/SiC composite between the SiC-converted faces of a pair of graphite rods It should be emphasized that the samples used had been cycled to 2400° F. during processing, which would cause severe thermal stress if there was poor CTE matching. Testing data have shown the interlaminar strength of the SiC/SiC CMC to be over 600 psi at room temperature, so the tensile strength of the adhesive must be higher than this value, as the failure occurred within the composite. That data is summarized below along with several other results from similar experiments.

TABLE 1

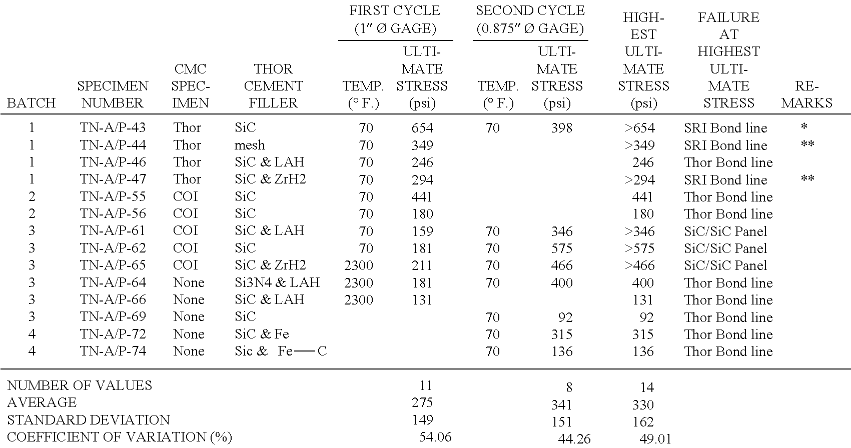

Preliminary tensile testing of rod to rod and rod/specimen bonding using ceramic adhesive.
(Highlighted values are the highest values for each specimen. Remarks: * Broke in threads on second cycle; ** Untested in second cycle -- too short to thread properly.)

It is believed that actual tensile strength of the adhesive of the present invention is approximately 1000-2000 psi or more. High temperature data taken at 2300° F. showed the tensile strength is greater than 200 psi, however the true strength value was not obtained due to failure of the attachment at the load train to graphite rod connection.

While the current invention has been shown to be useful as an adhesive for high temperature interlaminar tensile testing, its value as a joining agent for non oxide ceramics goes beyond that particular use. Generally, although the invention has been described in detail with particular reference to the above preferred embodiment(s), other embodiments can achieve the same results. Variations and modifications of the present invention will be obvious to those skilled in the art and it is intended to cover all such modifications and equivalents. The entire disclosures of all references, applications, patents, and publications cited above and/or in the attachments, and of the corresponding application(s) and parent application, are hereby incorporated by reference.

What is claimed is:

1. A nonaqueous, nonvolatile pre-ceramic paste composition useful for applications requiring high temperature strength and oxidation resistance, the composition comprising a uniformly-mixed and blended mixture of:
a. a liquid polymer precursor to a transition metal boride ceramic phase MBₓ wherein M is selected from the group consisting of Zr and Hf, and x ranges from 1 to 2, the precursor comprising a polymeric composition represented by the formula [MBₓH_{y}]ₙ wherein x is in the range 1 to 2, y ranges from 0 to 9 and n is a least 4, the precursor being capable of being converted into an amorphous or microcrystalline ceramic phase by being heated in an atmosphere selected from the group consisting of inert, reducing and vacuum, the precursor being derived from reacting an amine with M(BH₄)₄, where M is Zr or Hf, the precursor being present in the range 5% to 62% by weight of the composition;
b. a polymeric precursor to silicon carbide-based ceramic phase selected from the group consisting of a polysilazane and a polycarbosilane, the precursor being capable of mixing with the MBₓ precursor, the precursor being present in the range 5% to 62% by weight of the composition; and
c. a non-oxide ceramic powder having a grain size of less than 5 μm, the powder being selected from the group consisting of silicon nitride and silicon carbide, the powder blending with and suspending in the ceramic precursors at a level in the range 33% to 80% by weight of the composition without sieving the mixture, with the non-oxide ceramic powder to polymeric precursor ratio ranging from 0.5:1 to 4:1.

2. The nonaqueous, nonvolatile pre-ceramic paste composition useful for applications requiring high temperature strength and oxidation resistance of claim 1 wherein heat treatment yields ZrBₓ ceramic phases with domain sizes less than 0.5 μm.

3. The nonaqueous, nonvolatile pre-ceramic paste composition useful for applications requiring high temperature strength and oxidation resistance of claim 1 wherein the paste is capable of being used to infiltrate and modify porous materials, the porous materials selected from the group consisting of powder compacts, wood, minerals, ceramic matrix composites, graphite, carbon foams, ceramic materials, metallic foams, textiles and paper.

4. The nonaqueous, nonvolatile pre-ceramic paste composition useful for applications requiring high temperature strength and oxidation resistance of claim 1 wherein the paste is capable of being used as a high temperature adhesive, as a precursor to ceramic coatings, as a sealant or coating of silicon, ceramic matrix composites, or ceramic materials, including packages of electronic components or microelectronic machined micromechanical devices (MEMs), as sealant or coating of nuclear fuel rods, or as a material for fabrication of ceramic materials and composites, such as by extrusion or molding of ceramic parts or materials.

5. The nonaqueous, nonvolatile pre-ceramic paste composition useful for applications requiring high temperature strength and oxidation resistance of claim 1 wherein the paste is capable of being used for sealing of, bonding to, or joining of ceramic, ceramic composite, metallic, or carbon-based materials, parts, sensors, electronics, or feed-throughs, and to protect the integrity of those materials.

6. The nonaqueous, nonvolatile pre-ceramic paste composition useful for applications requiring high temperature strength and oxidation resistance of claim 1 wherein the paste is capable of being used to form ceramic coatings for high-temperature thermal protection, oxidation resistance, wear resistance, printing, jewelry, heating elements, ceramic matrix composites, glow plugs, gas-turbine components, filters, catalyst supports, glasses, armor, combustion chambers, prosthesis, or decorative coatings.

7. A nonaqueous, nonvolatile pre-ceramic paste composition useful for applications requiring high temperature strength and oxidation resistance, the composition comprising a uniformly-mixed and blended mixture of:
a. a liquid polymer precursor to a transition metal boride ceramic phase MBₓ wherein M is selected from the group consisting of Zr and Hf, and x ranges from 1 to 2, the precursor comprising a polymeric composition represented by the formula [MBₓH_{y}]ₙ wherein x is in the range 1 to 2, y ranges from 0 to 9 and n is a least 4, the precursor being capable of being converted into an amorphous or microcrystalline ceramic phase by being heated in an atmosphere selected from the group consisting of inert, reducing and vacuum, the precursor being derived from reacting an amine with M(BH₄)₄, where M is Zr or Hf, the precursor being present in the range 5% to 62% by weight of the composition;
b. a polymeric precursor to silicon carbide-based ceramic phase selected from the group consisting of a polysilazane and a polycarbosilane, the precursor being capable of mixing with the MBₓ precursor, the precursor being present in the range 5% to 62% by weight of the composition; and
c. a non-oxide ceramic powder having a grain size of less than 5 μm, the powder being selected from the group consisting of silicon nitride and silicon carbide, the powder being doped less than 5% by weight with powder selected from the group consisting of lithium, aluminum hydride, zirconium hydride, iron oxide, rare earth oxide, and hafnium carbide, the powder blending with and suspending in the ceramic precursors at a level in the range 33% to 80% by weight of the composition without sieving the mixture, with the non-oxide ceramic powder to polymeric precursor ratio ranging from 0.5:1 to 4:1.

8. The nonaqueous, nonvolatile pre-ceramic paste composition useful for applications requiring high temperature strength and oxidation resistance of claim 7 wherein heat treatment yields ZrBₓ ceramic phases with domain sizes less than 0.5 μm.
